(19) United States
(12) Patent Application Publication
(10) Pub. No.: US 2007/0011874 A1
(43) Pub. Date: Jan. 18, 2007

(54) Exhaust treatment devices and methods of making the same

(76) Inventor: Stephen Joe Myers, Owosso, MI (US)

Correspondence Address: Paul L. Marshall;Delphi Technologies, Inc., M/C 480-410-202, P.O. Box 5052, Troy, MI, 48007, US

(21) Appl. No.: 11/183,398

(22) Filed: Jul. 18, 2005

(51) Int. Cl. B01D 53/34; B21K 21/16

(52) U.S. Cl. 29/890; 29/401.1; 422/179

(57) ABSTRACT

Disclosed herein are exhaust treatment device designs and methods of assembly. In one embodiment an exhaust treatment device can comprise a substrate having a downstream end, a mat assembled around the substrate forming a substrate/mat sub-assembly wherein a portion of the mat extends beyond the downstream end, and a shell disposed around the substrate/mat sub-assembly. In another embodiment, the exhaust treatment device can comprise: a substrate having a downstream end, a foldable mat assembled around the substrate forming a substrate/mat sub-assembly, and a shell disposed around the substrate/mat sub-assembly. The foldable mat can comprise a folded section formed from a folded first edge of the foldable mat, and wherein the foldable mat comprises a non-folded section.

### TECHNICAL FIELD

This disclosure generally relates to exhaust treatment devices and specifically to substrate retention characteristics in exhaust treatment devices.

### BACKGROUND

Various exhaust treatment devices, such as NOx adsorbers, particulate filters, selective catalytic reduction catalysts, oxidation catalysts, and the like, have demonstrated to be very effective at remediating emissions produced by internal combustion engines. These devices can convert emissions such as, carbon monoxide (CO), carbon dioxide (CO₂), nitrogen oxides (NOx), and the like, into less undesirable species or compounds within a substrate.

Substrates are generally fabricated utilizing materials such as, but not limited to, cordierite, silicon carbides, metal oxides, and the like, which are capable of withstanding elevated operating temperatures of about 600° Celsius in underfloor applications and about 1,000° Celsius in manifold mounted or close coupled applications. Substrates are designed to comprise a large surface area and can be manufactured utilizing many designs, such as, but not limited to, foils, preforms, fibrous material, monoliths, porous glasses, glass sponges, foams, pellets, particles, molecular sieves, and the like. In addition, substrates can employ catalytic metals to encourage conversion of emissions.

Generally, substrates are contained within housing components comprising an outer “shell”, which is capped on either end with funnel-shaped “end-cones” that are connected to “snorkels” which allow for easy assembly to exhaust conduit. Housing components can be fabricated of any materials capable of withstanding the temperatures, corrosion, and wear encountered during the operation of the exhaust treatment device, such as, but not limited to, ferrous metals or ferritic stainless steels (e.g., martensitic, ferritic, and austenitic stainless materials, and the like).

Generally disposed between the shell and the substrate can be a retention material (a.k.a “mat” or “matting”) capable of insulating the shell from the high operating temperatures of the substrate, providing increased substrate retention by applying compressive radial forces about it, and provide the substrate impact protection. The matting is typically concentrically disposed around the substrate forming a substrate/mat sub-assembly.

Matting can exist in the form of a mat, particulates, preforms, or the like, and comprise materials such as, intumescent materials (e.g., a material that comprises vermiculite component, i.e., a component that expands upon the application of heat), non-intumescent materials, ceramic materials (e.g., ceramic fibers), organic binders, inorganic binders, and the like, as well as combinations comprising at least one of the foregoing materials. Non-intumescent materials include materials such as those sold under the trademarks “NEXTEL” and “INTERAM 1101HT” by the “3M” Company, Minneapolis, Minn., or those sold under the trademark, “FIBERFRAX” and “CC-MAX” by the Unifrax Co., Niagara Falls, N.Y., and the like. Intumescent materials include materials sold under the trademark “INTERAM” by the “3M” Company, Minneapolis, Minn., as well as those intumescent materials which are also sold under the aforementioned “FIBERFRAX” trademark.

Exhaust treatment devices can be assembled utilizing various methods. Three such methods are the stuffing, clamshell, and tourniquet assembly methods. The stuffing method generally comprises pre-assembling the matting around the substrate and pushing, or stuffing, the assembly into the shell through a stuffing cone. The stuffing cone serves as an assembly tool that is capable of attaching to one end of the shell. Where attached, the shell and stuffing cone have the same cross-sectional geometry, and along the stuffing cone's length, the cross-sectional geometry gradually tapers to a larger cross-sectional geometry. Through this larger end, the substrate/mat sub-assembly is advanced, which compresses the matting around the substrate as the assembly advances through the stuffing cones taper and is eventually pushed into the shell.

A clamshell assembly method can also be utilized to produce an exhaust treatment device assembly. This method generally comprises pre-assembling the matting around the substrate similar to the stuffing method, and assembling two mating shell-like halves around the substrate/mat sub-assembly. When assembled, these mating halves comprise the converter shell and can also comprise the end-cones and snorkels.

Another method of assembly is the tourniquet assembly method. Again, the tourniquet method comprises pre-assembling the matting around the substrate to form a substrate/mat sub-assembly. Once complete, a steel sheet can be wrapped around the substrate/mat assembly and fastened by a seam to comprise the converters shell.

The methods described above can be employed to produce an exhaust treatment device with a substrate and mat assembled therein. The performance characteristics desired of these devices can include; 1) minimize exhaust flow around the substrate, 2) axially retain the substrate during use, 3) provide insulation around the substrate to reduce heat loss through the shell, 4) provide impact protection for the substrate, and 5) cost competitiveness.

Balancing these properties is a challenge for device manufacturers as some properties conflict with others. For example, to achieve adequate axial substrate retention a high mat density can be employed; however, as mat density increases the insulative properties of the mat decreases. In another example, if retention properties are inadequate and the mat density should not be increased due to insulation requirements, manufactures have employed wire screens and wire rope for additional retention of the substrate. However, these additional components add processing steps and additional component costs which result in a less cost competitive product.

Manufacturers and designers desire further innovative solutions to meet these performance characteristics. Disclosed herein are novel solutions for meeting these performance characteristics

### BRIEF SUMMARY

Disclosed herein are exhaust treatment device designs and methods of assembly.

In one embodiment, the exhaust treatment device comprises a substrate having a downstream end, a mat assembled around the substrate forming a substrate/mat sub-assembly wherein a portion of the mat extends beyond the downstream end, and a shell disposed around the substrate/mat sub-assembly.

In another embodiment, the exhaust treatment device can comprise: a substrate having a downstream end, a foldable mat assembled around the substrate forming a substrate/mat sub-assembly, and a shell disposed around the substrate/mat sub-assembly. The foldable mat can comprise a folded section formed from a folded first edge of the foldable mat, and wherein the foldable mat comprises a non-folded section.

An embodiment of the method of retaining a substrate within an exhaust treatment device comprises disposing a mat around a substrate to form a substrate/mat sub-assembly wherein a portion of the mat extends beyond a downstream end of the substrate, and disposing the substrate/mat sub-assembly into a shell.

In another embodiment of the method of retaining a substrate within an exhaust treatment device comprises folding a first edge of a foldable mat to form a folded mat comprising a folded section and a not folded section, disposing the folded mat around a substrate to form a folded mat sub-assembly, and disposing the folded mat sub-assembly in a shell.

The above described and other features are exemplified by the following figures and detailed description.

### BRIEF DESCRIPTION OF THE DRAWINGS

Refer now to the figures, which are exemplary embodiments, and wherein the like elements are numbered alike.

FIG. 1 illustrates a cross-sectional view of exemplary substrate/mat sub-assembly 6.

FIG. 2 illustrates an annular cross-sectional view of exemplary substrate/mat sub-assembly.

FIG. 3 illustrates a cross-sectional view of exemplary substrate/mat sub-assembly with two extended ends.

FIG. 4, illustrates a partial and cross-sectional view of exemplary exhaust treatment device sub-assembly.

FIGS. 5a-5e illustrates partial and cross-sectional views of exemplary positive stop features.

FIG. 6, illustrates a top view of exemplary foldable mat.

FIG. 7 illustrates a cross-sectional view of exemplary folded mat sub-assembly.

FIG. 8 illustrates a cross-sectional view of exemplary folded mat converter assembly.

### DETAILED DESCRIPTION

Disclosed herein are designs of exhaust treatment devices with innovative substrate retention designs and methods of making the same. More specifically, exhaust treatment device assemblies will be described herein that utilize retention matting extending beyond the downstream end of the substrate to form a cushioned positive stop feature within the shell, which inhibits movement of the substrate beyond the positive stop feature. In addition, exhaust treatment device assemblies will be disclosed herein that employ retention matting folded back upon itself to form lengths of double-layered matting disposed between the substrate and the shell. Furthermore, the folded mat can extend past one or both ends of the substrate to form a cushioned positive stop when compressed between a positive stop feature within the exhaust treatment device shell and/or end-cone and the substrate, which inhibits movement of the substrate beyond the positive stop feature. These designs, and methods of producing the same, offer cost-effective solutions for increasing substrate retention and insulative properties, which are conducive for easy implementation in manufacturing.

The methods, assemblies, and designs disclosed herein are not limited to any specific exhaust treatment device. Any exhaust treatment device, such as, but not limited to catalytic converters, NOx adsorbers, selective reduction catalysts, oxidation catalysts, particulate filters, fuel reformers, and the like are capable of employing the technology disclosed herein. In addition, ranges disclosed herein are inclusive and combinable (e.g., ranges of “up to about 25 wt %, with about 5 wt % to about 20 wt % desired”, is inclusive of the endpoints and all intermediate values of the ranges of “about 5 wt % to about 25 wt %,” etc). Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

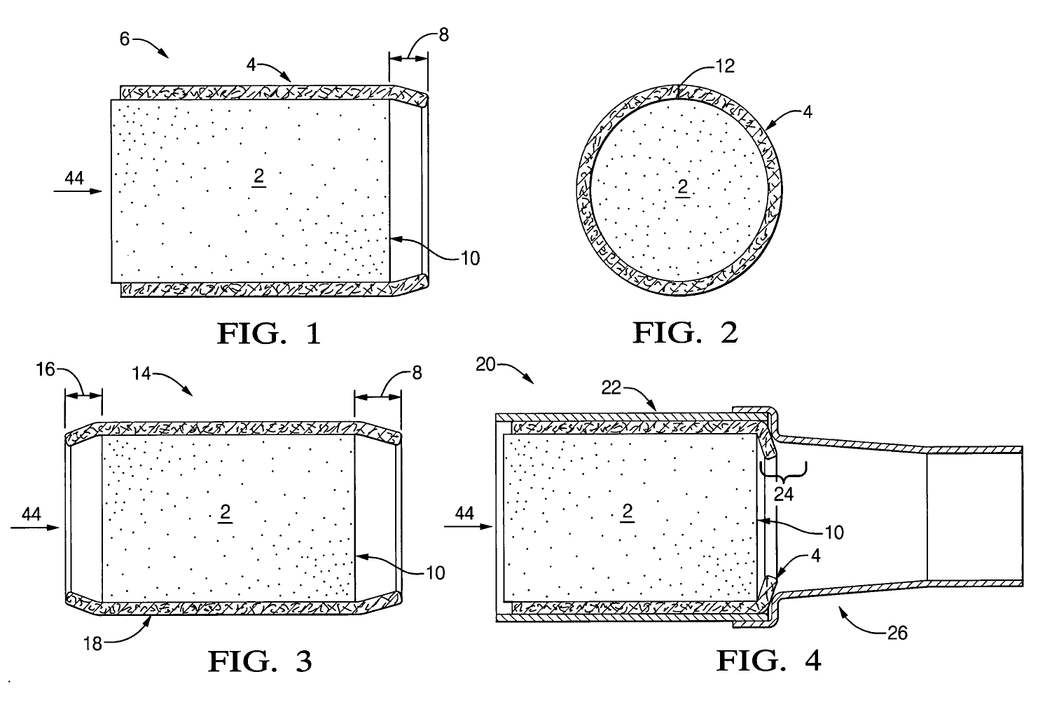

Referring now to FIG. 1, a cross-sectional view of an exemplary substrate/mat sub-assembly, generally designated 6, is illustrated. In this illustration, substrate 2 is disposed within mat 4. Mat 4 extends past the downstream end 10 of substrate 2, as shown by flow direction 44, by a first distance 8. In this embodiment, mat 4 is envisioned as being wrapped around substrate 2, however may be assembled together employing various methods. Furthermore, mat 4 can be permanently or temporarily fixed about substrate 2 utilizing methods such as, but not limited to, adhesive(s), pin(s), tape(s), film(s), wrap(s), sewing, stapling, crimping, and the like.

FIG. 2 illustrates an annular cross-sectional view of exemplary substrate/mat sub-assembly 6. In this illustration, substrate 2 is circular in design and annularly wrapped by mat 4. The ends of mat 4 meet at joint 12, which is illustrated as a butt-joint. The shape of substrate 2 can be of any cross-sectional geometry, such as, but not limited to, circular, elliptical, rectangular, polygonal, irregular, or the like. Furthermore, joint 12 can be any joint or intersection, including configurations that can aid in assembly or decrease exhaust flow around substrate 2, such as, but not limited to, tongue and groove configurations, L-shaped lap-joint, saw-tooth joint, dove-tail joint, irregularly shaped joint, or the like.

Referring now to FIG. 3, a cross-sectional view of an exemplary substrate/mat sub-assembly with two extended ends, generally designated 14, is illustrated. In this illustration, an elongated mat 18 is illustrated extending past the downstream end 10 of substrate 2 by a first distance 8 and by a second distance 16 on the other end. First distance 8 and second distance 16 may or may not be the same distance, and can be any distance, measured by any method.

Referring now to FIG. 4, a partial cross-sectional view of an exemplary exhaust treatment device sub-assembly, generally designated 20, is illustrated. In this illustration, shell 22 is attached to end-cone 26, and substrate/mat sub-assembly 6 (see FIG. 1) has been inserted therein. Substrate/mat sub-assembly 6 is disposed within shell 22 with mat 4 in contact with positive stop feature 24, which buckles, bends, deflects, compresses, or otherwise deforms mat 4 between positive stop 24 and substrate 2 inhibiting axial movement of substrate 2 in a downstream direction beyond positive stop feature 24 (as indicated by flow direction 44). It is further noted that mat 4 can comprise any thickness, configuration, or geometry, including configurations comprising tabs or protrusions disposed along the edge or ends of the mat that extend past the downstream end 10 of substrate 2 that can contact positive stop feature 24 and decrease material costs.

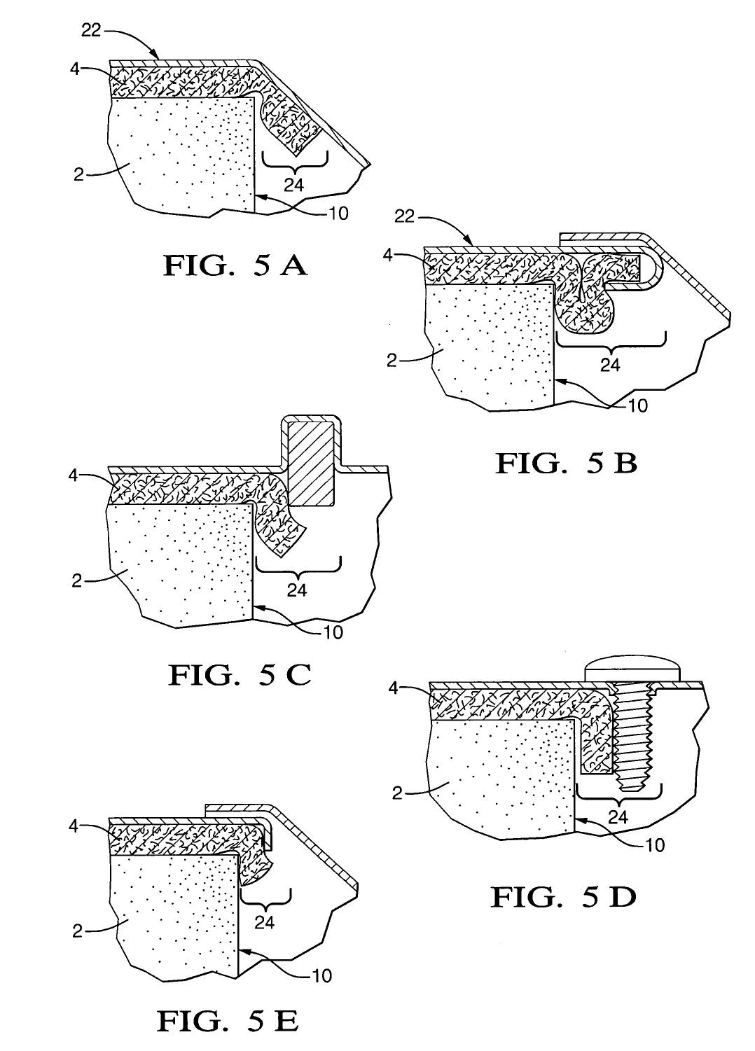

Positive stop feature 24 can be of any design that creates a smaller diameter than shell 22 or otherwise create an interference between substrate 2 and positive stop feature 24, such as, but not limited to, assembly configurations of shell 22 and/or end-cone 26, surface features of shell 22 and/or end-cone 26, or additional elements inserted into shell 22 and/or end-cone 26, such as, but not limited to, step(s), bump(s), rib(s), angle(s), crimp(s), stamping(s), lip(s), swage(s), ring(s) mount(s), fastener(s), press-fit(s), screw(s), snap(s), clamp(s), bolt(s), pin(s), dowel(s), rivet(s), weld(s)), and the like. FIGS. 5b-5e illustrate various exemplary configurations of positive stop features 24 that are proposed for exemplary and illustrative purposes and are not limiting of all potential positive stop feature 24 configurations (e.g., an end feature on the shell (FIG. 5b (e.g., a hook, curve, or the like) and FIG. 5e (e.g., a shelf, or the like), a protrusion into the shell (FIGS. 5c and 5d (e.g., a rivet, screw, stopper, and the like), a crimp, rib, extension, and the like), a protrusion from the endcone (not shown), and the like, as well as combinations comprising at least one of the foregoing. In FIG. 5a, instead of a positive stop feature, the end-cone inner surface is employed to engage the mat 4 that extends beyond the downstream end of the substrate 2.

It is intended that housing components and positive stop features 24 can be assembled, fixed, or mounted to one another so as to inhibit exhaust leakage at a seam such as, fastening, swaging, stamping, press-fitting, screwing, snapping, welding, fusing, clamping, bolting, riveting, doweling, pinning, crimping, peening, and the like. It is also envisioned that shell 22 and end-cone 26 can be of one continuous piece of metal (e.g. spin formed, swaged, crimped, stamped, and the like).

Any assembly method can be utilized for producing exhaust treatment devices utilizing the substrate/mat sub-assembly 6, such as, but not limited to, stuffing, clamshell, or tourniquet assembly methods, and the like. Viable assembly methods are not limited by extending mat 4 beyond substrate 2. However, positive stop feature 24 may differ between exhaust treatment devices designed for various assembly methods.

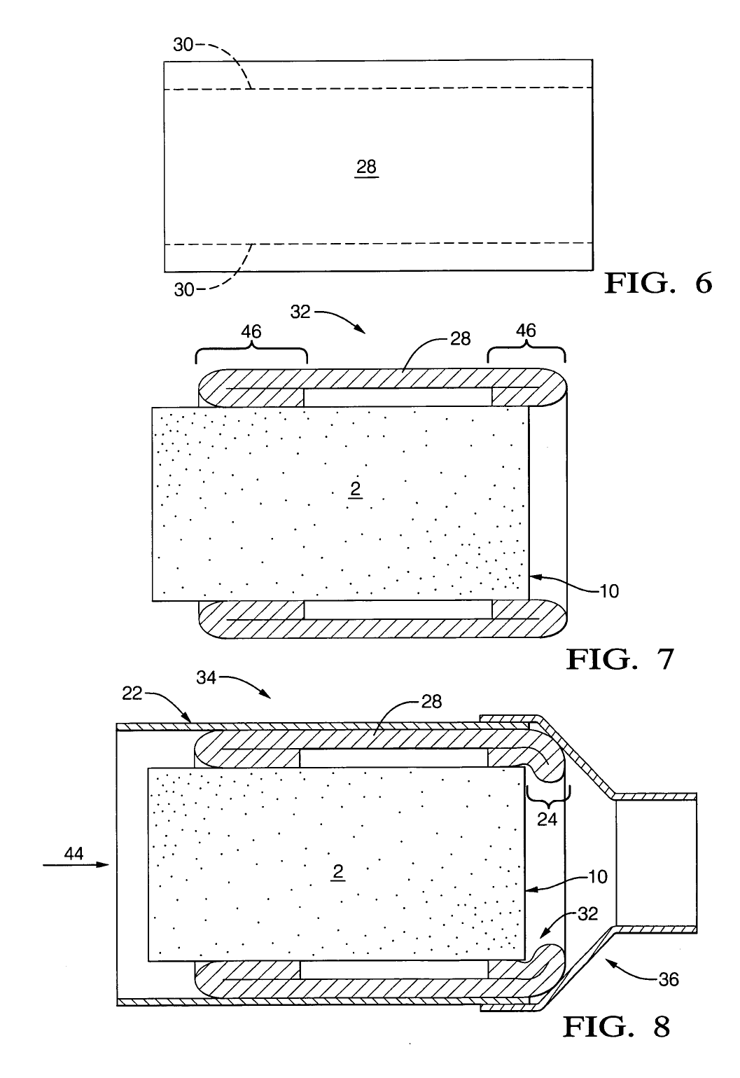

Referring now to FIG. 6, a top view of exemplary foldable mat 28 is illustrated. In this illustration, foldable mat 28 is depicted a rudimentary rectangular form with two proposed fold lines 30 disposed on the mat's surface illustrating locations where the sides of the mat can be folded over to overlay on itself prior to being wrapped around a substrate 2. Foldable mat 28 can comprise any thickness, configuration, or geometry, including configurations comprising tabs or protrusions disposed along the edge of the mat extending beyond the downstream end 10 of substrate 2, which can decrease material costs.

FIG. 7 generally illustrates a cross-sectional view of an exemplary folded mat sub-assembly, generally designated 32, in its expanded state (non-compressed state). In this illustration foldable mat 28 has been folded back upon itself, forming a folded sections 46, and wrapped around substrate 2. Although not shown, it is envisioned that foldable mat 28 can be folded in any orientation and can comprise one or more folds. It is also envisioned that foldable mat 28 can be cut partially though the thickness of the mat along fold lines 30 in order to ease folding.

FIG. 8 generally illustrates an exemplary folded mat device sub-assembly, generally designated 34. In this illustration folded mat sub-assembly 32 has been inserted into shell 22, and is illustrated with foldable mat 28 folded over upon itself on both ends. The folded end that is downstream, per flow direction 44, extends past the end of substrate 2 and compresses against the inner surface of the endcone 36 to inhibit axial movement of substrate 2, in the flow direction 44. It is noted that one or both ends may or may not extend past the ends of substrate 2, and the shell and/or endcone may or may not have positive stop feature 24. For example, in an embodiment where the folded sections do not extend beyond the ends of substrate 2, the folded portions would provide sufficient force to fix substrate 2 in position during use. In the embodiment illustrated (in FIG. 8), the upstream end of folded mat sub-assembly 32 does not extend past the upstream end of substrate 2 and does not incorporate a positive stop feature 24. Additionally, the leading edge of foldable mat 28 contacts the tapered inside diameter of end-cone 36 and is deflected towards the center of the endcone. Movement of substrate 2 is inhibited beyond the point where the stop feature 24 as foldable mat 28 physically contacts the end cone.

In this embodiment it is envisioned that the folded ends of mat 4 can provide improved retention of substrate 2 as compared to a single layer of mating, as their dual layers are higher in density than the single layer of matting disposed there between. These folded sections can have a density of about 0.85 grams per cubic centimeter (g/cc) to about 1.2 g/cc, where the lower density single layer matting can be about 0.5 g/cc to about 0.7 g/cc in density. Furthermore, it is also envisioned shell 22 can be configured in any geometry that enables the specific embodiments disclosed herein, e.g., the shell may have a contour to allow the annulus between catalyst and shell to be less than double in the insulation area. Moreover, it is to be apparent that alternative shell configurations can be designed to allow for the use of multi-density mats, e.g., Interam 1101HT (3M Company, Minneapolis, Minn.).

Several embodiments of exhaust treatment device assemblies have been disclosed herein. The first embodiment comprises the extension of matting material beyond the downstream end 10 of substrate 2 which can be compressed between a positive stop feature 24 and the substrate 2, thereby inhibiting the movement of substrate 2 beyond positive stop feature 24 when under the pressures of operation.

Although this assembly may be assembled utilizing any method, in stuffing operations this offers additional benefits. Firstly, the matting that extends beyond the downstream end 10 of substrate 2 assists in guiding the substrate/mat sub-assembly 6 into shell 22. Second, as substrate 2 is pressed into shell 22, mat 4 cushions substrate 2, which reduces the potential for damage to substrate 2, and increases the ease of automated equipment to sense when the substrate/mat sub-assembly 6 bottoms within the shell 22.

The second embodiment comprises a foldable mat 28 that can be folded, wrapped around a substrate 2, and inserted into a shell 22. This embodiment offers increased substrate 2 retention on its ends, which are two or more adjacent layers of matting, when compressed and annularly disposed between shell 22 and substrate 2. In this configuration, the folded ends of the foldable mat 28 produce relatively high density areas compared to the mat's single layer area. The lower-density single layer area of matting, disposed between the high-density folded ends, however offers the additional benefit of improved insulation due to its lower density. Lastly, if the folded section of foldable mat 28 is extended past the downstream end 10 of substrate 2, this matting can be compressed between positive stop feature 24 and substrate 2, which inhibits the movement of substrate 2 beyond positive stop feature 24.

The innovative exhaust treatment devices and the methods for substrate 2 retention disclosed herein offer innovative solutions for meeting various performance characteristics desired by device manufacturers, such as axially retaining the substrate during use, providing insulation around the substrate to reduce heat loss through the shell, impact protection for the substrate, and cost competitiveness.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An exhaust treatment device, comprising:
a substrate having a downstream end;
a mat assembled around the substrate forming a substrate/mat sub-assembly, wherein a portion of the mat extends beyond the downstream end; and
a shell disposed around the substrate/mat sub-assembly.

2. The exhaust treatment device of claim 1, further comprising a positive stop feature disposed near the downstream end, wherein the portion of the mat is in physical contact with the positive stop feature.

3. The exhaust treatment device of claim 2, wherein the positive stop feature is selected from the group consisting of a protrusion from the shell, an end feature on the shell, and a protrusion from the endcone, and combinations comprising at least one of the foregoing.

4. A method of retaining a substrate within an exhaust treatment device, comprising:
disposing a mat around a substrate to form a substrate/mat sub-assembly, wherein a portion of the mat extends beyond a downstream end of the substrate; and
disposing the substrate/mat sub-assembly into a shell.

5. The method of claim 4, wherein the portion of the mat contacts a positive stop feature.

6. The method of claim 5, further comprising:
measuring an assembly force as the portion of mat contacts the positive stop feature; and
discontinuing the assembly force when the assembly force is greater than or equal to a predetermined force.

7. A method of retaining a substrate within an exhaust treatment device, comprising:
folding a first edge of a foldable mat to form a folded mat comprising a folded section and a not folded section;
disposing the folded mat around a substrate to form a folded mat sub-assembly; and
disposing the folded mat sub-assembly in a shell.

8. The method of claim 7, wherein at least a portion of the folded section extends beyond a downstream end of the substrate.

9. The method of claim 8, wherein the portion contacts a positive stop feature.

10. The method of claim 9, further comprising:
measuring an assembly force as the portion of mat contacts the positive stop feature; and
discontinuing the assembly force when the assembly force is greater than or equal to a predetermined force.

11. The method of claim 7, further comprising folding a second edge of the foldable mat to form a second folded section; and
disposing the second folded section near an upstream end of the substrate.

12. An exhaust treatment device, comprising:
a substrate having a downstream end;
a foldable mat assembled around the substrate forming a substrate/mat sub-assembly, wherein the foldable mat comprises a folded section formed from a folded first edge of the foldable mat, and wherein the foldable mat comprises a non-folded section; and
a shell disposed around the substrate/mat sub-assembly.

13. The exhaust treatment device of claim 12, wherein at least a portion of the folded section extends beyond a downstream end of the substrate.

14. The exhaust treatment device of claim 12, further comprising a positive stop feature disposed near the downstream end, wherein at least a portion of the folded section is in physical contact with the positive stop feature.

15. The exhaust treatment device of claim 14, wherein the positive stop feature is selected from the group consisting of a protrusion from the shell, an end feature on the shell, and a protrusion from the endcone, and combinations comprising at least one of the foregoing.
